(19) United States
(12) Patent Application Publication
(10) Pub. No.: US 2009/0067472 A1
(43) Pub. Date: Mar. 12, 2009

(54) Infrared thermometer and detecting head component thereof

(76) Inventors: Vincent Weng, HsinChu (TW); Kevin Lin, HsinChu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/289,774

(22) Filed: Nov. 4, 2008

(30) Foreign Application Priority Data
Jun. 11, 2007 (TW) 96141803

(51) Int. Cl. G01J 5/00; G01K 1/08

(52) U.S. Cl. 374/121; 374/208; 374/E01.011

(57) ABSTRACT

The present invention discloses an infrared thermometer and a detecting head component thereof. The novel detecting head component is located on the top of the infrared thermometer. The detecting head component includes a shell, n infrared detector inside the shell, and a sleeve unit, coupled to the part of the shell which contacts with a measuring object. The infrared thermometer in the present invention can increase the comfortableness of user during using the infrared thermometer.

### BACKGROUND OF THE INVENTION

1. Field of the Invention

The invention relates to an infrared thermometer and a detecting head component thereof, and more particularly, to an infrared thermometer and a detecting head component to increase the comfortableness of user during using the infrared thermometer.

2. Description of the Related Art

The infrared ear or forehead thermometers are well known in the art and commonly used to determine the body temperature based on the infrared radiation technology. The advantage of utilizing the infrared thermometer lies in the almost accurate result, and easy and fast measure process. With the accelerated development of the infrared radiation technology, the infrared thermometer becomes one of the most important meters in nowadays.

Please refer to FIG. 1. FIG. 1 is a diagram schematically showing an ear thermometer of a conventional technology. As shown in FIG. 1, the conventional ear thermometer 10 includes a main body 12 and a detecting head component 14 which located on the main body 12. The detecting head component 14 further includes a shell 141, and an infrared detector (not shown) which placed inside the shell 141 and coupled to a control unit (not shown). The infrared detector is utilized for detecting the infrared radiation around the ear drum, and sending a thermal detecting signal to the control unit. After receiving the thermal detecting signal, the control unit will transfer it into a temperature value and show the temperature value on the display unit 16.

One of the operation processes of the infrared ear thermometer is mainly inserting the detecting head into the ear canal to detect the infrared radiation around the ear drum. The detecting head inevitably has a contact with the skin of the ear canal. However, the temperature of the detecting head was oftentimes different with the temperature of the ear canal. For example, if the user utilizes the thermometer under cold or cool weather, the variation of temperature of the detecting head and the human body will cause the user uncomfortable and unpleasant. Thus, the unavoidable discomfort severely hinders the implementation of the infrared ear thermometer.

Therefore, to solve the above-mentioned problems, the present invention proposes a novel infrared thermometer and the detecting head component thereof.

### SUMMARY OF THE INVENTION

The present invention discloses an infrared thermometer and a novel detecting head component thereof. The detecting head component in the present invention significantly improves the comfortableness of using the thermometer. The detecting head component includes a sleeve unit. The sleeve unit is made by elastomer material with poor thermal conductivity. The temperature coefficient and variation of the sleeve unit will be much lower than the related art infrared ear thermometer. That is, the infrared thermometer in the present invention can provide the users more relaxed and soft using environment.

It is therefore one of the many objectives of the claimed invention to provide an infrared thermometer. The infrared thermometer includes a main body, comprising a user interface and a display unit; a detecting head component, coupled to one node of said main body, wherein said detecting head component comprises a shell; and an infrared detector, located in said shell, for detecting an infrared radiation of a measuring object; a sleeve unit, coupled to one part of said shell, wherein said part of said shell is the part of contacting with said measuring object; and a control circuit, coupled to said user interface, said display unit, and said infrared detector, wherein said control circuit activates said infrared detector to detect a temperature of said measuring object based on said user interface, receives a temperature detecting signal by said infrared detector, transforms said temperature detecting signal into a measuring value, and sends said measuring value to said display unit for displaying said measuring value.

Below, the embodiments of the present invention are described in detail in cooperation with the attached drawings to make easily understood the objectives, technical contents, characteristics and accomplishments of the present invention.

### BRIEF DESCRIPTION OF THE DRAWINGS

FIG. 1 is a diagram schematically showing an ear thermometer of a conventional technology.

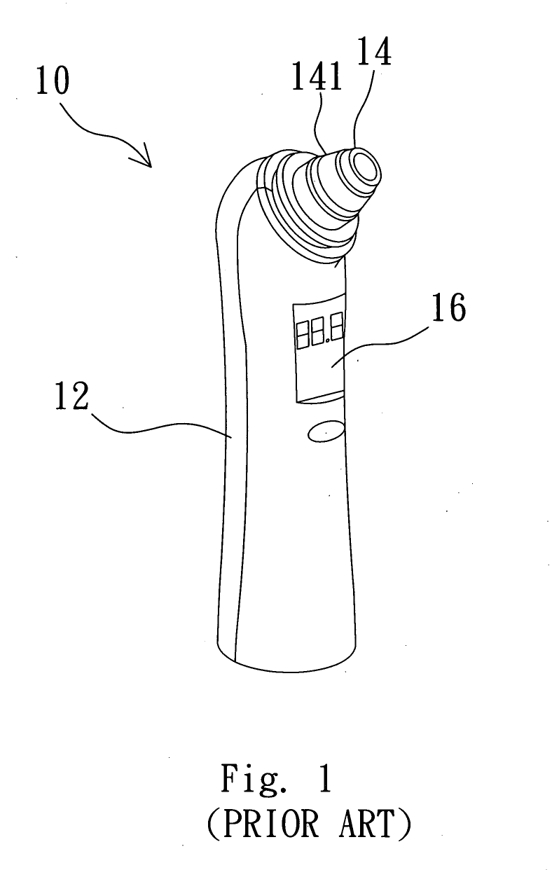

FIG. 2 is a diagram schematically showing an infrared ear thermometer according to a first embodiment of the present invention.

FIG. 3 shows a block diagram of the related connection for each component in the infrared ear thermometer according to the present invention.

FIG. 4 is a diagram schematically showing an infrared ear thermometer according to a second embodiment of the present invention.

FIG. 5 is a cut-away view of the detecting head component according to the present invention.

### DETAILED DESCRIPTION OF THE INVENTION

The present invention discloses an infrared thermometer and a novel detecting head component thereof. The detecting head component in the present invention significantly improves the comfortableness of using the thermometer. Please note that, the following description of embodiment is based on the infrared ear thermometer. However, the infrared ear thermometer is only an example of the present invention, and is not meant to be taken as limitations. That is, as will be easily observed by a personal of ordinary skill in the art, other embodiments of the present disclosure (e.g. infrared forehead thermometer) are also possible.

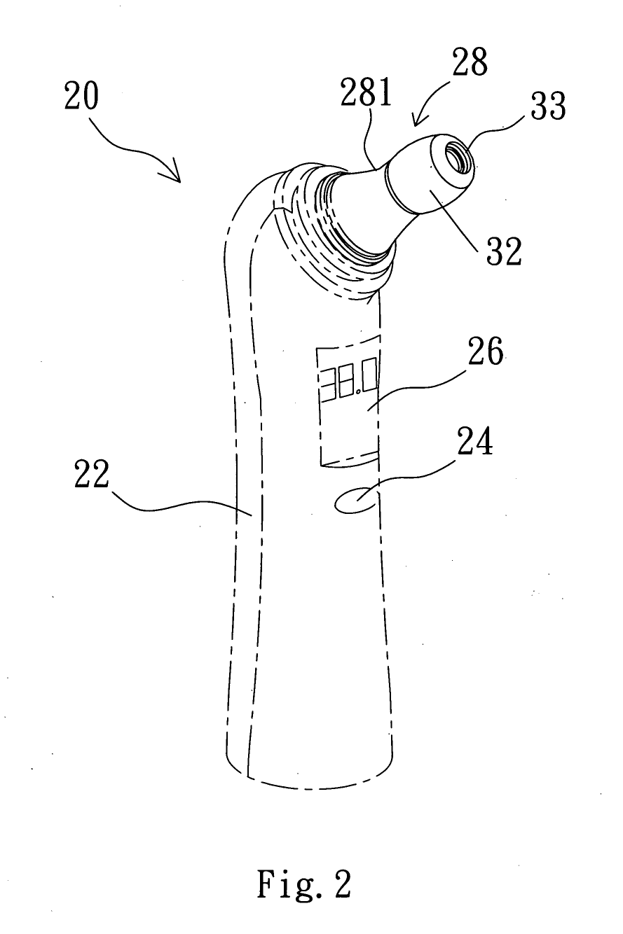

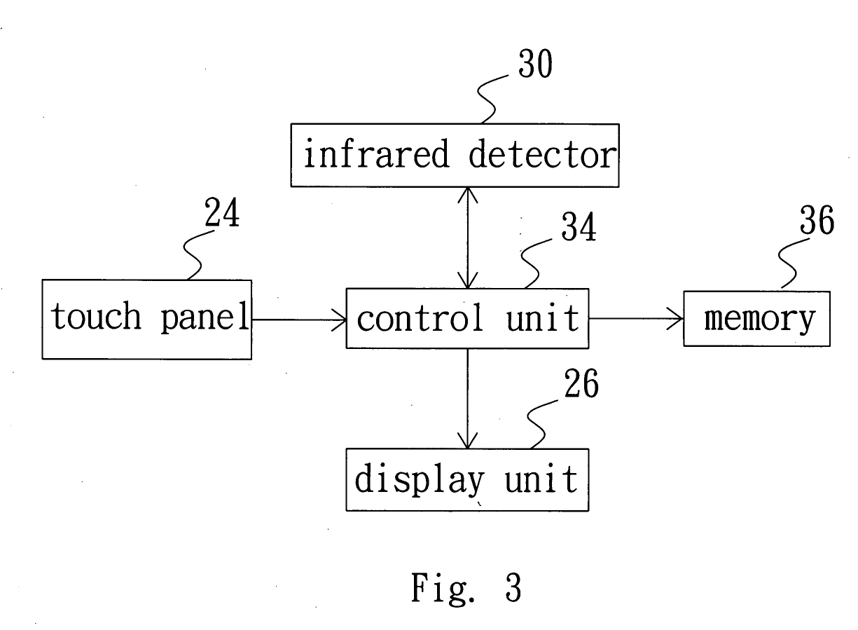

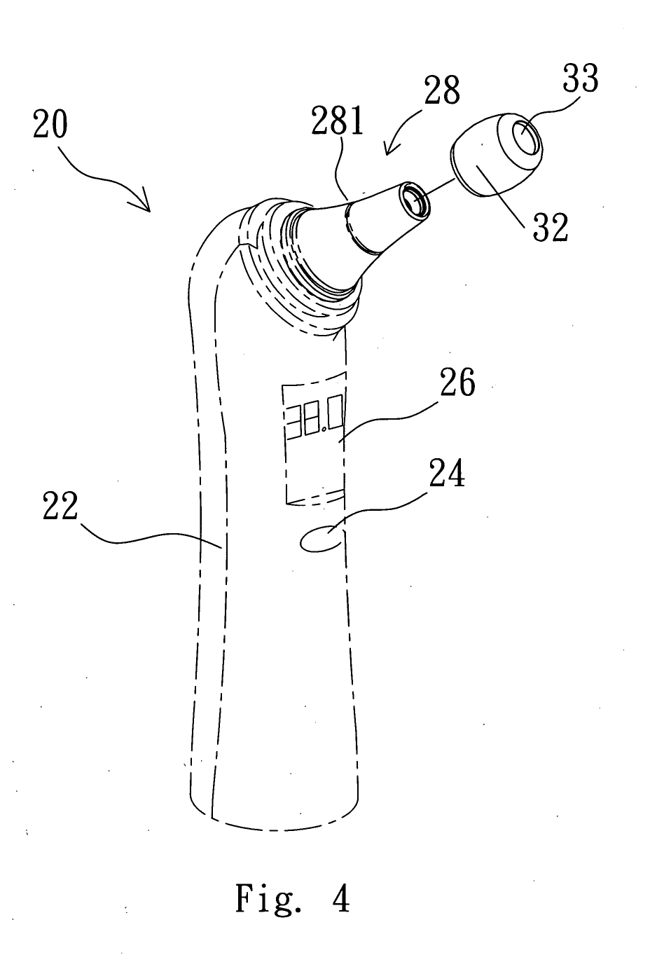

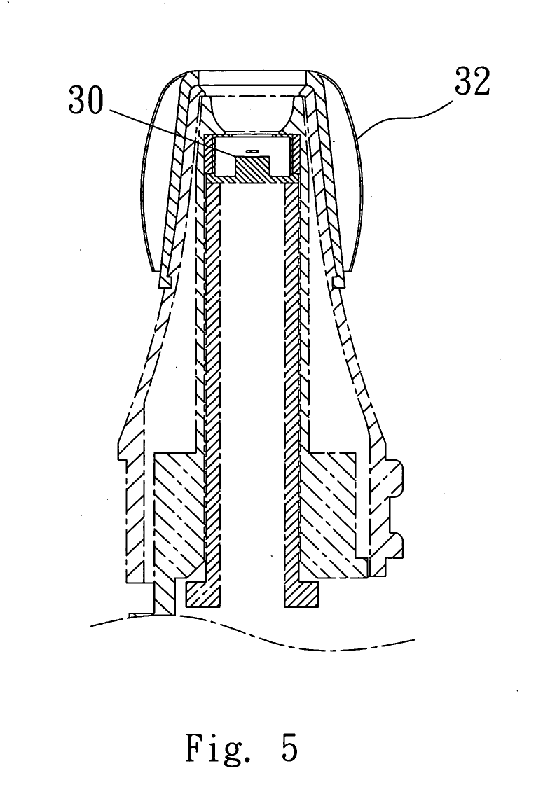

Please refer to FIG. 2 in conjunction with FIG. 3. FIG. 2 is a diagram schematically showing an infrared ear thermometer according to the present invention. And FIG. 3 shows a block diagram of the connection for each component in the infrared ear thermometer according to the present invention. As shown in FIG. 2, the infrared ear thermometer 20 in the present invention includes a main body 22, a user interface (e.g. a touch penal 24), which is coupled to the surface of the main body 22, for initiating the temperature detecting process, and a display unit 26 (e.g. a LCD monitor) for displaying the measuring result. Moreover, the infrared ear thermometer further includes a detecting head component 28 coupled to the main body 22. The detecting head component 28 includes a shell 281 with a window on the top to allow the infrared radiation of detecting objects into the shell 281. In this embodiment, the detecting object is the human's ear. The infrared radiation around the ear canal will transmit into the detecting head component 28 through the window. The detecting head component 28 further includes an infrared detector, located inside the shell 281, to detect the infrared radiation from the window. Moreover, the detecting head component 28 in the present invention includes a sleeve unit 32 located on the top of shell 281. Please note that, many possible variations can be configured to assemble the sleeve unit 32 and the shell 281, and as such, configurations obtaining the same objective also belong to the claimed invention. For example, the sleeve unit 32 and the shell 281 can be made of one piece, as shown in FIG. 2, or be separate parts, as shown in FIG. 4. The sleeve unit 32 has a hole 33 corresponding to the window of the detecting head component 281. Additionally, the sleeve unit 32 can be made by elastomer material (e.g. robber, or plastic component), which is poor thermal conductor. Furthermore, the detecting head component 28 in the present invention further includes a control circuit 34, and a memory 36 located in the main body 22. The control circuit 34 is coupled to the touch penal 24, the display unit 26, the infrared detector 30 and the memory 36. The memory 36 is utilized for storing the temperature measuring result. Please refer to FIG. 5. FIG. 5 is a cut-away view of the detecting head component according to the present invention. FIG. 5 clearly illustrates the relative position between the shell 281 of the detecting head component 28 and the sleeve unit 32.

As mentioned above, the detecting head component 28 first places into the ear canal to measure the temperature around the ear canal. Meanwhile, the sleeve unit 32 of the shell 281 will make a contact with the ear canal. When the user pushes the touch panel 24 on the infrared ear thermometer, the control circuit 34 will activate the infrared detector 30 to perform the measuring process. That is, the infrared detector 30 will detect the infrared radiation around the ear canal and send a temperature detecting signal to the control circuit 34. Next, the control circuit 34 will transform the temperature detecting signal into a measuring value, and then display the measuring value on the display unit 26. Meanwhile, the control circuit 34 also sends the measuring value to the memory 36 so as to store the data.

In contrast to the related art infrared ear thermometer, the infrared ear thermometer of the present invention provides more comfortable and soft touch for users due to the elastomer material of the sleeve unit 32. Moreover, because the elastomer material of the sleeve unit 32 is a poor thermal conductor, the temperature coefficient and variation of the sleeve unit will be much lower than the related art infrared ear thermometer. That is, the users will not touch cold or cool detecting head any more.

Therefore, the infrared ear thermometer of the present invention proposes a novel detecting head component to reduce the discomfort of traditional infrared ear thermometer, and therefore, to provide the users more relaxed and soft using environment.

Those described above are only the preferred embodiments to exemplify the present invention but not to limit the scope of the present invention. Any equivalent modification or variation according to the shapes, structures, features and spirit disclosed in the specification is to be also included within the scope of the present invention.

What is claimed is:

1. A detecting head component, coupled to a main body of an infrared thermometer, comprising:
a shell;
an infrared detector, located in said shell, for detecting an infrared radiation of a measuring object; and
a sleeve unit, coupled to one part of said shell, wherein said part of said shell is the part of contacting with said measuring object.

2. The detecting head component of claim 1, wherein said sleeve unit is made by an elastomeric material with poor thermal conductivity.

3. The detecting head component of claim 1, wherein said sleeve unit and said shell are made of one piece.

4. The detecting head component of claim 1, wherein said sleeve unit and said shell are separated parts.

5. The detecting head component of claim 1, wherein said shell comprises a window, in the front of said shell, for providing a pathway to said infrared detector for detecting said infrared radiation through said window.

6. An infrared thermometer, comprising:
a main body, comprising a user interface and a display unit;
a detecting head component, coupled to one node of said main body, wherein said detecting head component comprises a shell; and an infrared detector, located in said shell, for detecting an infrared radiation of a measuring object;
a sleeve unit, coupled to one part of said shell, wherein said part of said shell is the part of contacting with said measuring object; and
a control circuit, coupled to said user interface, said display unit, and said infrared detector, wherein said control circuit activates said infrared detector to detect a temperature of said measuring object based on said user interface, receives a temperature detecting signal by said infrared detector, transforms said temperature detecting signal into a measuring value, and sends said measuring value to said display unit for displaying said measuring value.

7. The infrared thermometer of claim 6, wherein said user interface comprises at least a touch panel.

8. The infrared thermometer of claim 6, further comprising a memory, coupled to said control unit, for storing said measuring value.

9. The infrared thermometer of claim 6, wherein said shell comprises a window, in the front of said shell, for providing a pathway to said infrared detector for detecting said infrared radiation through said window.
